(19) United States
(12) Patent Application Publication
(10) Pub. No.: US 2018/0132598 A1
(43) Pub. Date: May 17, 2018

(54) DRINK CONTAINERS

(71) Applicant: Tom Kim, Los Angeles, CA (US)

(72) Inventor: Tom Kim, Los Angeles, CA (US)

(21) Appl. No.: 15/615,629

(22) Filed: Jun. 6, 2017

Related U.S. Application Data
(60) Provisional application No. 62/473,220, filed on Mar. 17, 2017.
(60) Provisional application No. 62/423,301, filed on Nov. 17, 2016.

(51) Int. Cl. A45F 3/16; B65D 47/06; A61J 11/00; B65D 55/00

(52) U.S. Cl. CPC A45F 3/16; B65D 47/06; B65D 2203/00; B65D 55/00; A61J 11/00

(57) ABSTRACT

Provided is a container for drinking liquid comprising: a. a reservoir for holding liquid, the reservoir made from a material that shrinks as liquid leaves the reservoir, b. an opening for the liquid to leave the reservoir and exit the container; and c. a one way valve configured to be actuated by a person sucking the opening; wherein when the person sucks, the one way valve opens and the liquid leaves the container while the reservoir shrinks to compensate for volume of the liquid that left the container. In another embodiment, provided is a container for drinking liquid comprising: a) a housing in a shape of a phallus, the housing having a body and a cap, inside of the body of the housing having a reservoir for a liquid, the cap configured to be removably attached to the housing; and b) a channel in the cap configured to carry liquid from inside of the housing to outside of the container: wherein the reservoir is tilled by removing the cap, and pouring the liquid into the reservoir, and the liquid is consumed through the channel. Provided is a container for drinking liquid comprising: a) a body; b) a cap for removably attaching to the body, the cap having an opening configured to allow liquid to travel from inside of the container to outside of the container; c) a cup for holding liquid placed inside of the body, the cup maintained in proximity to, a top of the body; Wherein liquid leaves the cup and moves to the outside of the container through the opening in the cap. Also provided are mannequins in assembly with such containers.

### CROSS-REFERENCE

The present application claims the benefit of U.S. Appl. No. 62/385,161, filed on Sep. 8, 2016 and U.S. App. No. 62/473,220, filed on Mar. 17, 2017, which are incorporated herein by reference in their entirety.

### BACKGROUND SECTION OF THE INVENTION

People have a need to drink liquids, either to quench thirst or for entertainment. Different liquids, such as water, juice, or alcohol are typically drunk froin relatively boring containers. Furthermore, the container has to be often washed to keep it sanitary. There is a need in the art for containers to drink liquid in a sanitary and entertaining manner.

### SUMMARY SECTION OF THE INVENTION

Provided is a container for drinking liquid comprising: a. a reservoir for holding liquid, the reservoir made from a material that shrinks as liquid leaves the reservoir, b. an opening for the liquid to leave the reservoir and exit the container; and c. a one way valve configured to be actuated by a person sucking the opening; wherein when the person sucks, the one way valve opens and the liquid leaves the container while the reservoir shrinks to compensate for the volume of liquid that left the container. The container can further include a housing in which the container is placed. The housing can be phallus shaped. The housing can be shaped as a cylinder. The housing can be shaped as a baby milk bottle. The housing can be shaped as an adult toy. The housing can be made from a rigid material that does not shrink due to shrinkage of the container. An opening can exist for exchange of air between inside and outside of the housing. The container can, further comprise a separator inside of the reservoir to maintain stability of the reservoir when liquid leaves the container. The separator can be a rod. The container can further comprise a slot before the one way valve for liquid to leave the reservoir. The housing can be made from one layer or alternatively at least two layers, with an outside layer that is made from a material that is compressible and an inner layer made from a material that is not compressible. The housing can be made from two parts, a body and a cap, the body and the cap, configured to threadably be attached to each other. The cap can have a channel for liquid to move outside of the housing. The cap in a shape of a nipple to simulate breast of a woman, or the shape of lips or vagina. The container can further comprise a member fabricated from one piece, the member having a spout on top, a slot in liquid communication with the spout, and a separator positioned below the slot, wherein liquid leaves through the slot and moves through the spout to outside of the container. The member can be attached to an extension inside the cap or one that comes downward from the cap, resulting in the member to be in fluid communication with outside of the housing. The valve can be placed above the spout. The member can be sealed to the material that shrinks.

Provided is a container for drinking liquid comprising: a) a housing in a shape of a phallus, the housing having a body and a cap, inside of the body of the housing having a reservoir for a liquid, the cap configured to be removably attached to the housing; and, b) a channel in the cap configured to carry liquid from inside of the housing to outside of the container; wherein the reservoir is filled by removing the cap and pouring the liquid into the reservoir, and the liquid is consumed through the channel, wherein the only opening that the container with the cap in place has is the channel. The cap and the body can have complementary threading. A plug can be placed inside of the channel and be removable from outside of the channel.

Provided is a container for drinking liquid comprising: a) a body; b) a cap for removably attaching to the body, the cap having an opening configured to allow liquid to travel from inside of the container to outside of the container; c) a cup for holding liquid placed inside of the body, the cup maintained in proximity to a top of the body; wherein liquid leaves the cup and moves to the outside of the container through the opening in the cap. The cup can have a flange portion, the flange portion configured to rest on top of the body. The container further comprises a one way valve placed in between the cup and the opening of the cap, the valve having an assembly that rests on the flange portion of the cup. The container can be phallus shaped. The container can be shaped as a baby milk bottle. The container can be shaped as an adult toy. The cup can shrink as liquid leaves the cup. The body can be made from at least two layers, with an outside layer that is a made from a material that is compressible and an inner layer made from a material that is not compressible. The body and the cap can be threadably attached to each other. The container can further comprise a one way valve placed in between the cup and the opening of the cap. The one way valve can be an umbrella valve.

Provided is a mannequin or a portion thereof, comprising: a) one or more cavities in proximity to where a person's mouth, breast, vagina, vagina, or anus is located; b) a container configured to hold a liquid placed in the cavity, the container having an opening for drinking the liquid, wherein the opening is accessible from outside of the mannequin and a user can drink the liquid from the container while the container is placed partially or fully inside the cavity of the mannequin. The mannequin can be a male mannequin with a container opening coming out of the container for at least 2 inches. The mannequin can have access from back side of the cavity for placing and removing the container. The cavity and the container can have complementary threads for removably attaching the container. The two cavities can be positioned where a breast of the mannequin would ordinarily be placed, each of the cavities having threading, and each of the cavities threadably attached to a single container. Each of the containers placed in position of the breast can have a nipple for a user to drink the liquid.

### BRIEF DESCRIPTION OF THE FIGURES

FIG. 1 is front view of adult toy.

FIG. 2 is a cross section view of the adult toy with a closed valve.

FIG. 3 is a cross section view of the adult toy with an open valve.

FIG. 4 illustrates the adult toy.

FIG. 5 illustrates the adult toy.

FIG. 6 illustrates the adult toy.

FIG. 7 illustrates back view of the housing for the adult toy.

FIG. 8 illustrates side view cross section of housing for the adult toy.

FIG. 9 illustrates side view of a liquid container.

FIG. 10 front view cross section of a liquid container.

FIG. 11 illustrates front view cross section of a liquid container.

FIG. 12 illustrates mannequin side view with nippled liquid container mounting.

FIG. 13 illustrates mannequin front view with nippled liquid container mounting.

FIG. 14 illustrates front view of nippled liquid container for mannequin.

FIG. 15 illustrates side view, cross section, of nippled liquid container for mannequin.

FIG. 16 illustrates side view of container spout.

FIG. 17 illustrates front view cross section of container spout.

FIG. 18 illustrates front view of container spout.

FIG. 19 illustrates detailed cross section of one-way valve.

FIG. 20 illustrates exploded view of the one-way valve.

FIG. 21 illustrates front view of baby bottle assembly.

FIG. 22 illustrates cross-section side view of baby bottle assembly.

FIG. 23 illustrates side view of liquid container.

FIG. 24 illustrates front view of liquid-less liquid container.

FIG. 25 horizontal cross-section front view of liquid-less container.

FIG. 26 illustrates a partial vertical cross-section of front view showing movement of liquid.

FIG. 27 illustrates a mannequin with a bottle placed in a cavity in the face and the nipple of the bottle accessible from the lips.

FIG. 28 illustrates a mannequin with a bottle placed in a cavity in the torso and the nipple of the bottle accessible from the vagina.

FIG. 29 illustrates a bottle with the nipple of the bottle shaped like lips.

FIG. 30 illustrates the head of a male mannequin with a phallus shaped container sticking out of the mouth.

FIG. 31 illustrates the torso of a male mannequin with a phallus shaped container.

FIG. 32 is an isometric exploded view of adult toy.

FIG. 33 illustrates front view of an adult toy.

FIG. 34 illustrates cross-section of an adult boy.

FIG. 35 illustrates a side view of the adult toy.

FIG. 37 illustrates section B-B of FIG. 35.

FIG. 38 illustrates a side view of valve assembly o-ring sealer.

FIG. 39 illustrates a top view of valve assembly with valve assembly chassis.

FIG. 40 illustrates bottom view of valve assembly with valve assembly chassis.

FIG. 41 illustrates an exploded isometric view of one way valve assembly.

FIG. 42 illustrates isometric view of valve assembly with valve assembly chassis.

FIG. 43 illustrates cross section of top view of FIG. 39 valve assembly.

FIG. 44 cross section of toy with valve in normally closed position.

FIG. 45 illustrates cross section of toy with valve in open position via user mouth suction.

FIG. 46 illustrates isometric view of valve assembly in a closed position.

FIG. 47 illustrates isometric view of valve assembly in an open position.

FIG. 48 illustrates a phallus shaped cup where a user fills in the liquid as desired.

FIG. 49 illustrates a phallus shaped cup where a user fills in the liquid as desired.

### DETAILED DESCRIPTION OF THE INVENTION

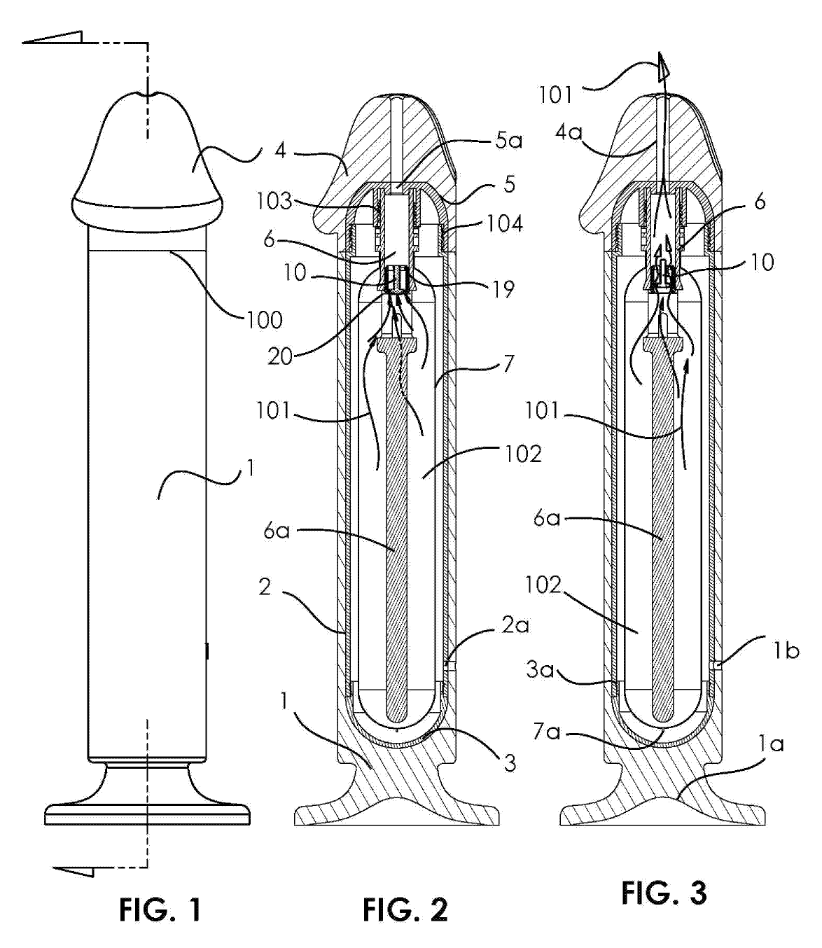

FIGS. 1-8 illustrate a drink container in the shape of an adult toy, in this case a phallus. A liquid for drinking is placed inside of the phallus.

FIG. 1 illustrates a front view of adult toy, showing the outside of the adult toy. Body 1 can be made with an overmold of a soft cover on a hard material, or alternatively from a single material that is not porous to a liquid. FIG. 1 illustrates the soft cover of body 1 with a similar feel and hardness to human tissue. A suitable soft material can be TPE gels in the 50 Shore OOO to 80 Shore OO range. Examples of TPEs include Styrenic block copolymers (TPE-s or TPS compounds based on SBS, SEBS), Polyolefin blends (TPE-O or TPO), Elastomeric alloys (TPE-V or TPV), Thermoplastic polyurethanes (fPE-U or TPU), Thermoplastic copolyester (TPE-E or TPC), and Thermoplastic polyamides (TPE-A or TPA). Body 1 can be cylindrical in shape. The hard part can be made from metal, plastic, glass, wood, fabric, ceramic, and carbon-fiber. Glass is typically used for a one-layer housing.

To cover the top of the body and to give the look of a phallus, Cap 4 in shape of glans can cover the top of body 1. Cap 4 can be made from a soft cover (over mold). The cap 4 on body 1 can create a cap-body split line 100. Cap 4 can have threading that can be, used to removably and threadably attach cap 4 to body 1.

FIG. 2 is a cross-section view of the adult toy of FIG. 1. Disclosed in this figure are body soft cover (over mold) 1, body housing hard shell (over mold) 2, body housing hard shell air exchange hole 2a, body housing cap hard shell (over mold) 3, cap (glans) soft cover (over mold) 4, cap hard shell (over mold) 5, cap liquid access hole 5a, liquid flow direction 101, air-less liquid 102, cap liquid container engagement threads 103, cap/body over molds engagement threads 104, flexible liquid container 7, valve seal o-ring assembly (closed position) 10, valve housing 19, and valve retainer ring 20.

FIG. 2 illustrates placing container 7 inside of body 1. Container 7 is made from a flexible material that shrinks/collapses as liquid leaves container 7, compensating for the loss of volume of the liquid. The container can include a liquid that is airless. Examples of liquids include water, juice, soda, alcohol, wine, vodka, tequila, whiskey, or a liquid simulating a human fluid in taste and/or looks (such as semen). A separator 6a extending from substantially the top of the container 7 to bottom of container 7 can be included to keep the container 7 stable, particularly as liquid 102 leaves the container 7. The separator 6a as shown in FIG. 2 is filled and does not allow for movement of liquid. In another embodiment, the separator is a straw with a cavity inside and optional perforations on the sides to allow for movement of liquid. The separator 6a is positioned below and attached to spout 6. Liquid 102 leaves through slot 6d on spout 6. Positioned above slot 6d is one way valve housing 19. Valve housing 19 contains valve 10, which is configured to be actuated by force of suction of a person's mouth. Liquid leaving the valve 10 moves up spout 6 and moves into liquid access hole 4a (channel) of cap 4. The liquid then exits the toy from top of hole 4a on cap 4. FIG. 2 illustrates valve 10 in a closed position and FIG. 3 illustrates valve 10 in an open position, allowing for movement of liquid pass valve 10. The container can be made by welding a flexible material, which can result in the container having a seam 7a.

FIG. 3 is a cross section view with open valve 10. This figures discloses liquid flow direction 101, air-less liquid 102, mounting suction cup 1a, body housing soft shell air exchange hole 1b, body housing cap snap ring 3a, cap (glans) soft cover liquid access hole 4a, liquid container spout 6, flexible container film separator 6a. flexible container welded seam 7a, and valve seal o-ring assembly (opened position) 10. Item 6a, is an extension of spout unit and acts as a spacer to allow the liquid to flow out of flexible container via user mouth suction. Check-valve item 10 prevents air to replace liquid exiting out of the housing. Flexible container item 7 remains airless until all the liquid is consumed. This toy can be used in any universal position while liquid is still available. Liquid container can be disposable while the over molded housing can be reusable and also dishwasher safe. Alternatively the Liquid container can be reusable.

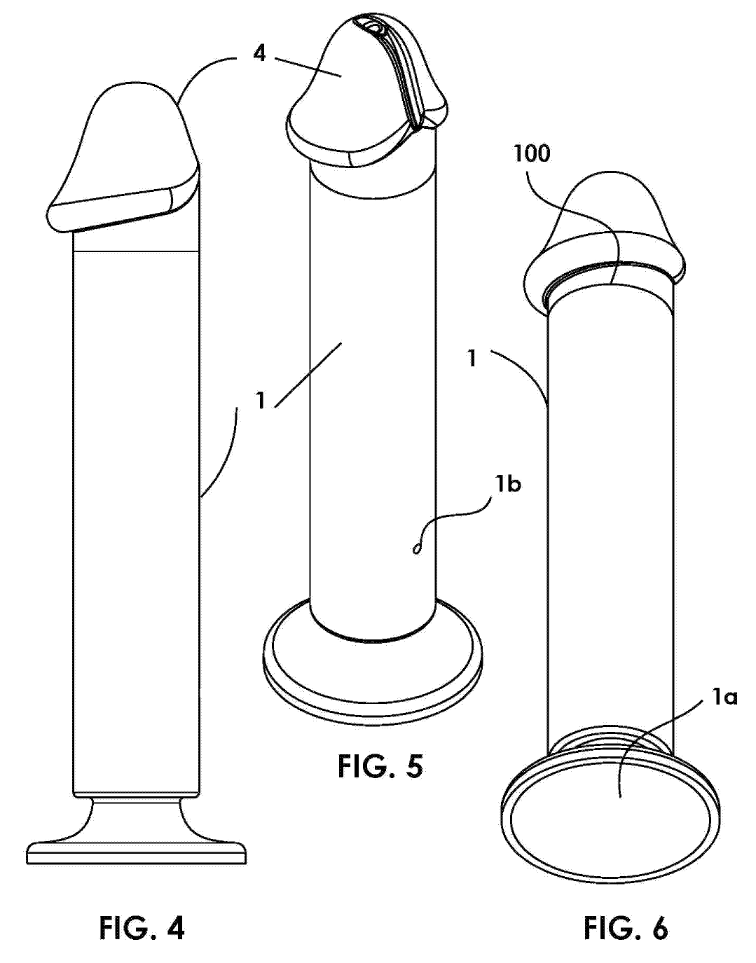

FIG. 4 illustrates a side view of the adult toy with the phallus shaped body 1. Illustrated in this view are body soft cover (over mold) 1, and cap (glans) soft cover (over mold) 4. The bottom of the toy can have mounting suction cup 1a.

FIG. 5 illustrates an isometric front side view of the adult toy with the phallus shaped body 1. Illustrated in this view are body soft cover (over mold) 1, body housing soft shell air exchange hole 1b, and cap (glans) soft cover (over mold) 4.

FIG. 6 illustrates a perspective view of adult toy with body soft cover (over mold) 1, mounting suction cup 1a, and cap body split line 2b. Mounting suction cup 1a can be used to removably attach the adult toy to a flat surface, and to stabilize the adult toy in an upright position. Cap 4 can further have a channel on the outside in between the two bulges that runs from access hole opening 4a to the bottom of the bulge area on cap 4.

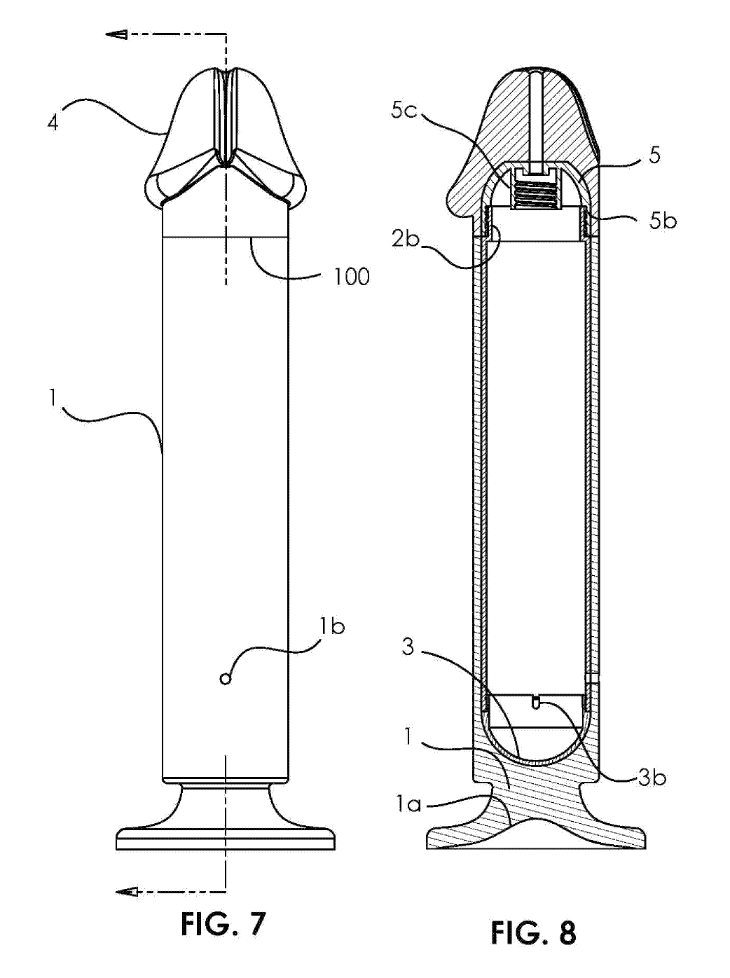

FIG. 7 illustrates back view of reusable housing of the adult toy. This view illustrates body soft cover (over mold) 1. air exchange hole 1b, cap body split line 100, and cap (glans) soft cover (over mold) 4. Air exchange hole 1b allows for exchange of air from outside of the housing with air in between the container and the housing in the inside of housing.

FIG. 8 illustrates side view cross section of reusable housing of the adult toy. This view illustrates body soft cover (over mold) 1, mounting suction cup 1a, body housing hard shell threaded receptacle for cap 2b, body housing cap hard shell (over mold) 3 (which is in shape of a sphere and is used to cap the bottom part in the manufacturing process), body housing cap snap deflection slot 3b. Placed on top of the body is cap 4, which is overmolded on cap hard shell 5. Cap threaded receptacle 5c extends down and is configured to receive a spout. The housing illustrated in FIG. 8 is reusable, and can be washed after each use. A container having a liquid for consumption is placed in the housing. Cap 4 and body 1 can have a rigid inner hard shell. The rigid shell 3 of body 1 extends above the soft outer layer, of the body on top, and has threading to accept the cap. The threaded portion can be positioned on a shoulder, which is a portion of the rigid shell with a smaller diameter. When cap 4 is placed on the body, the threaded portion 5b (Cap threaded receptacle) of rigid portion 5 of cap complements the threads on the body. Cap hard shell 5 also has an extension 5c that comes down inside the body and has threading. The extension is configured to receive spout 6 and be threadably attached to spout 6. After attachment, the spout is in fluid communication with access hole 4a, allowing the fluid to leave cap 4 and the container altogether.

As illustrated in FIG. 8, the housing is configured so that a spout is attached to receptacle 5c. In another embodiment, receptacle 5c is absent and a person uses the toy as a regular cup that has to be filled up by a user.

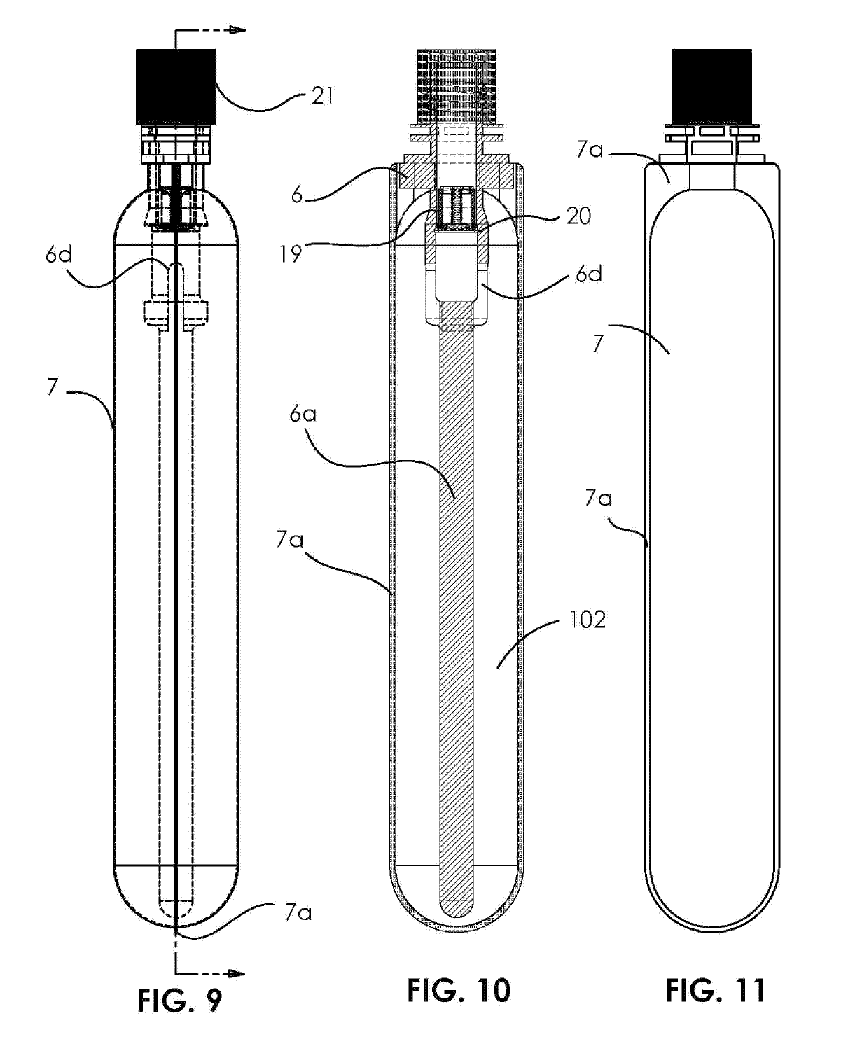

FIG. 9 illustrates side view of a disposable liquid container. Illustrated in this view are liquid container spout 6, spout liquid flow side access slot 6d, flexible liquid container 7, flexible container welded seam 7a, and liquid container shipping cap (throw away) 21. Flexible liquid container 7 is made from a material that shrinks/collapses as a user consumes liquid. By collapsing, the bottle compensates for loss of volume resulting from consumption. This bottle can be a stand-alone bottle, or have a hard housing as illustrated in FIG. 10

FIG. 10 illustrates front view cross section of disposable liquid container with a rigid housing. In this view, illustrated are liquid container spout 6, flexible container film separator 6a, spout liquid flow side access slot 6d, flexible liquid container 7, flexible container welded seam 7a, valve retainer ring 20, air-less liquid 102. The separator 6a maintains the length of the flexible liquid container 7. Illustrated is also seam 7a that can result from, the manufacture of the flexible container.

FIG. 11 illustrates front view cross section of disposable liquid container. Illustrated in this view are flexible liquid container 7 and flexible container welded seam 7a.

The liquid container illustrated in, FIGS. 9-11 can be stand alone or have a phallus shaped housing. Cap 21 can be removed when using a phallus shaped or other type of housing. When a user sucks, the user actuates the one way valve of the bottle so that liquid can leave the bottle. The container 7 then shrinks.

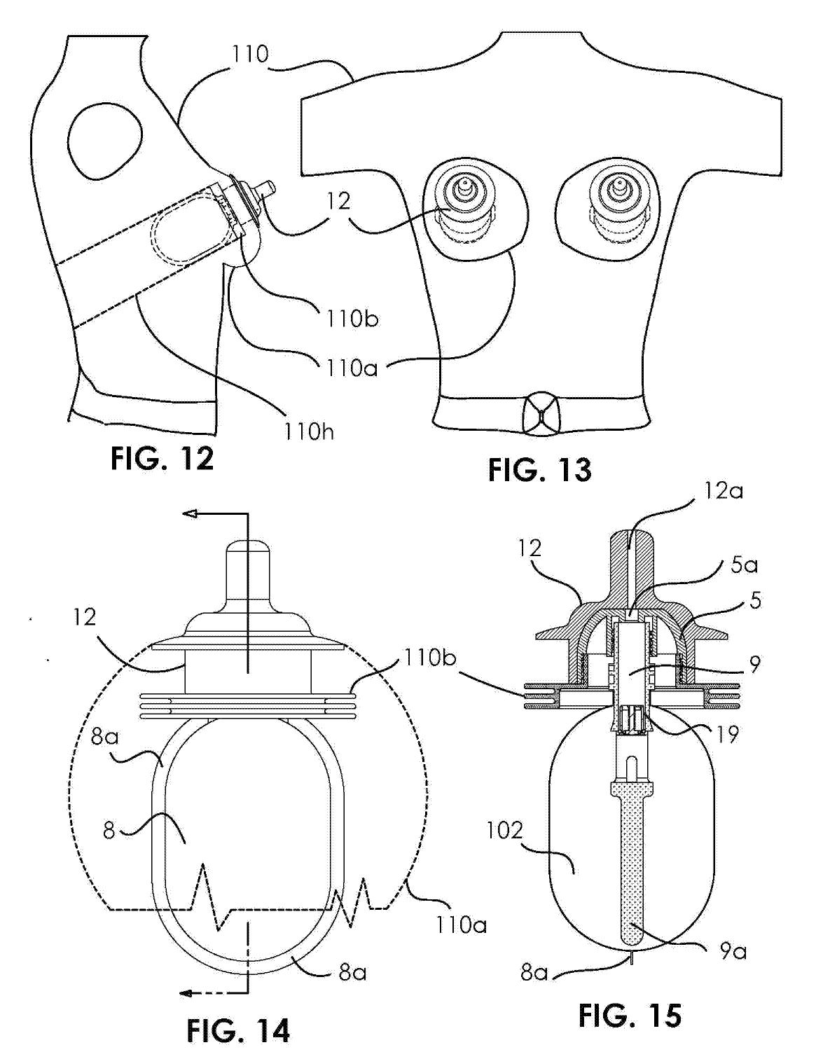

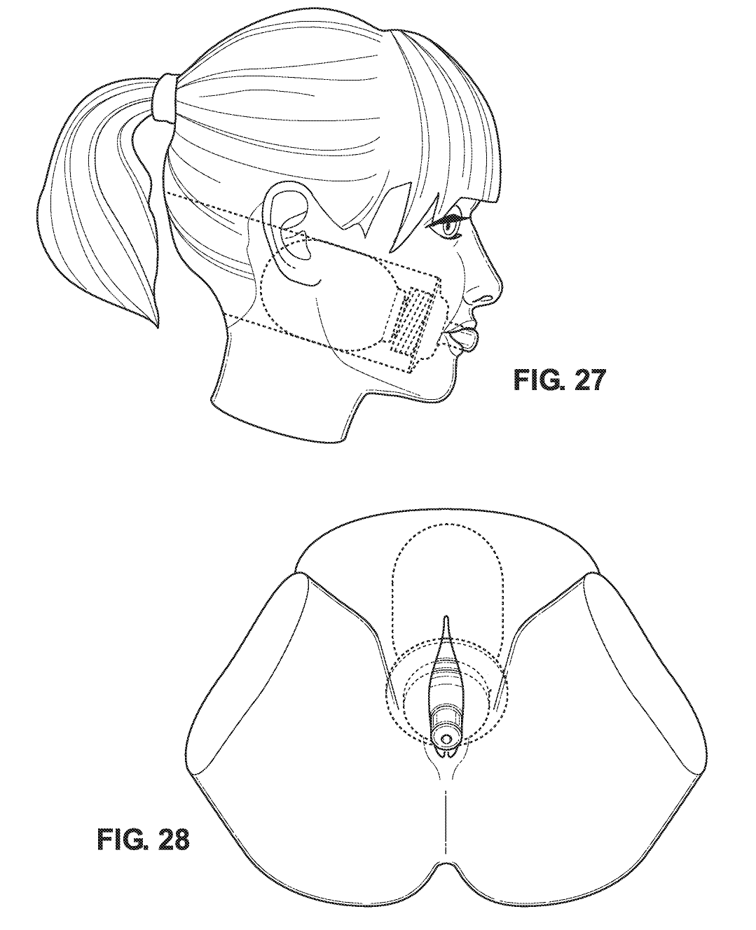

As illustrated in FIGS. 12-15 and FIGS. 27-28, a bottle containing a liquid can also be placed inside a cavity of a mannequin. The cavity can be formed in position of the mouth, genitals, vagina, breasts, and anus. FIG. 12 illustrates a mannequin side view of the torso. Illustrated in this view are disposable nippled liquid container mounting cap (nipple) soft cover (over mold) 12, mannequin 110, mannequin breast 110a, mannequin breast threaded insert receptacle (mounting tbd) 110b. In this embodiment, container 8 is placed in a cavity of the mannequin where the breasts of the mannequin are typically present. The portion of container 8 holding the liquid is inside of the mannequin and the nippled portion 12, which is a nipple-shaped cap, is outside of mannequin 110. When a user sucks on nipple 12, one way valve opens, and liquid from container 8 enters the cap, and then the person's mouth. In this embodiment, only the nippled portion 12 of the bottle is visible from outside of the mannequin 110. The bottle can be removably placed inside the mannequin 110 cavity. If the breasts of the mannequin are made from a soft material like silicone, the fins 110b on the bottle would stabilize the bottle by pressing on the silicone. FIG. 27 illustrates placing the bottle in the head of a mannequin, with the nippled portion sticking out of the lips of the mannequin. There can be an access from the back of the head for accessing the cavity to place and remove the bottle. There can be similar access from back for breasts and other genitals. Alternatively there can be front access for placing the bottle. The bottle can be placed as a stand-alone or as part of an assembly that includes a member simulating human part. For example, the bottle can be placed inside a soft material that resembles a human breast, and then the human breast having the bottle incorporated therein is attached to the mannequin. FIG. 28 illustrates the bottle being placed in a cavity of the torso to simulate a human vagina. Instead of a nipple, the part of the mouth configured to touch the moth can be a lip or a vagina, to simulate other parts of the body.

FIG. 13 illustrates mannequin front view. Container 8 is secured to the cavity in the mannequin. Illustrated in this view are disposable nippled liquid container mounting cap (nipple) soft cover (over mold) 12, mannequin 110, mannequin breast 110a. A person can suck on the nippled portion 12 to drink the liquid inside the container. The bottle can be placed from the front or the back depending on the design of the mannequin. The container 8 can also be placed as part of a bottle having a hard shell.

FIG. 14 illustrates container 8 that is placed inside of the mannequin in the upper torso where the mannequin's breasts would be located. Container 8 is secured to the cavity in the mannequin. Illustrated in this figure are disposable nippled liquid container for mannequin cap (nipple) soft cover (over mold) 12, short flexible liquid container 8, and flexible container welded seam 8a, and mannequin breast threaded insert receptacle (mounting tbd) 110b.

FIG. 15 illustrates side view, cross section of disposable nippled liquid container 8. Illustrated in this view is cap hard shell (over mold) 5, cap liquid access hole 5a, flexible container welded seam 8a, liquid container spout 9, flexible container film separator (short) 9a, cap (nipple) soft cover (over mold) 12, cap (nipple) soft cover liquid access hole 12a, valve housing 19, air-less liquid 102, flexible container welded seam 7a. The soft cover 12 can be overmolded on hard shell 5. Hard shell 5 can have an extension that comes down and has threading to be threadably and removably attached to liquid container spout 9. The spout can be fabricated as one piece having spout 9 and separator 9a. Valve housing 19 can be placed inside the spout to control movement of liquid 102 from inside the container to outside of the container. The flexible liquid container 8 shrinks as liquid 102 leaves the container. Container 8 can be made by welding a flexible material, which can result in a seam 8a. Container 8 can also be welded to spout 9 be heating to seal container 8.

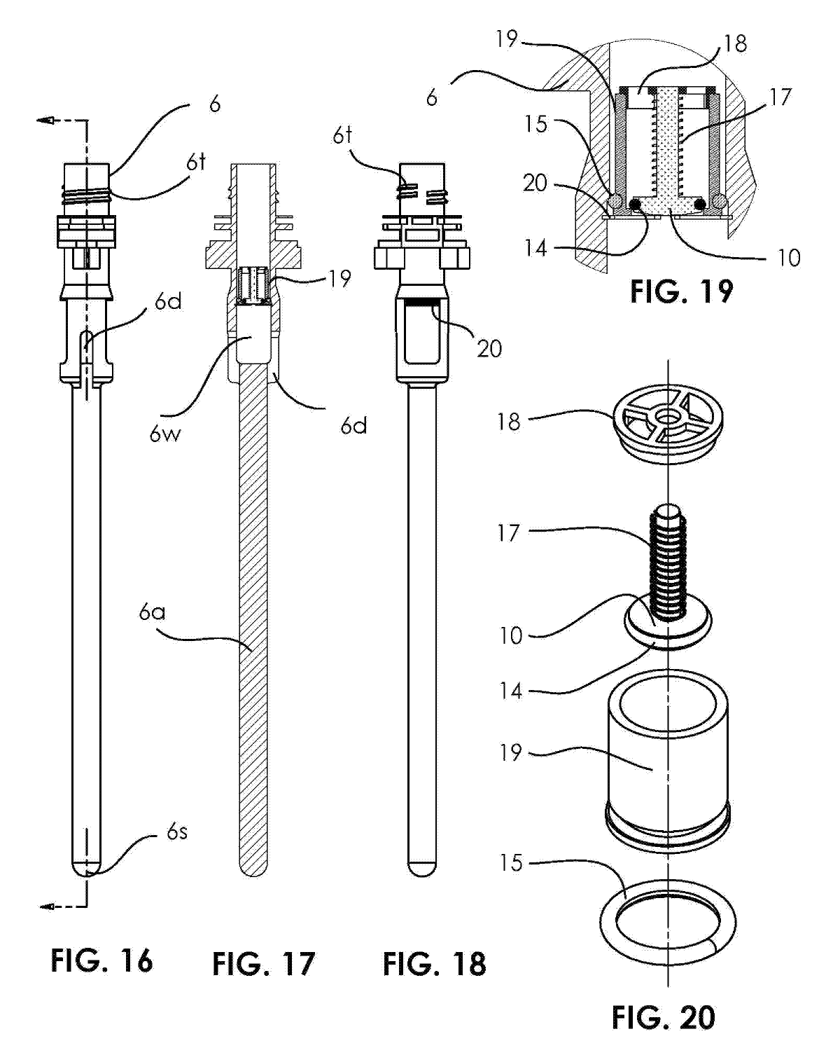

FIG. 16 illustrates side view of container spout liquid container spout 6. This view illustrates the spout liquid flow side access slot 6d and separator puncture-proof spherical tip 6s. The entire spout 6 (from top to 6S) can be fabricated from one piece of material, typically plastic. The spherical bottom 6s minimizes chance of puncturing the container. Liquid leaves the reservoir of the container through slot 6d and then travels through spout 6 to outside of the container. Spout 6 has threading on top for threadable attachment to member 5c extending below rigid portion of the cap, as illustrated in FIG. 8.

FIG. 17 illustrates front view cross-section of container spout 6. In addition to relative small lots 6d, the spout 6s has larger slots 6w, for a total of 4 slots, spaced relatively equidistant from each other. Illustrated in this view are flexible container film separator 6a, spout liquid flow side access slot 6d, spout liquid flow front/back, access slot 6w. Also illustrated in this view is valve housing 19, which contains a one way valve. The valve housing 19 is positioned in between above access slot 6d,which with slots 6w, are the only pathway the liquid has to travel from the inside of the container to outside of container.

FIG. 18 illustrates front view of container spout 6. Illustrated in this view is valve retainer ring 20. Valve retainer ring 20 mounts the valve assembly on spout 6, and maintains the position of the valve assembly parallel to the spout. Valve retainer ring 20 can be a compressible ring, which is compressed first, and then positioned in the spout 6, resulting in expansion and forming a stable assembly with spout 6. In this view, valve retainer ring 20 is slightly visible on top of slot 6w. Also shown in this view is threading 6t on outside of spout 6. Threading 6t complements the threading on inside of SC, and is configured to allow the spout to be threadably attached to cap 5.

FIG. 19 illustrates detailed cross section of the one-way valve. Illustrated in this view are one-way valve liquid container spout 6, valve (closed position) 10, valve seal o-ring 14, valve housing seal o-ring 15, valve spring 17, valve spring retainer cap 18, valve housing 19, valve retainer ring 20.

FIG. 20 illustrates exploded view of the one-way valve. Illustrated in this view are valve 10, valve seal o-ring 14, valve housing seal o-ring 15, valve spring 17, valve spring retainer cap 18, and valve housing 19. When a user sucks on the bottle, valve 10 moves upward as regulated by spring 17, opening a passageway for movement of liquid. Spring 17 sits on stem of valve 10 and is compressed and provides resistance as valve 10 moves upward. Valve spring retainer cap 18, which snaps into housing 19, has a central opening that allows the step of valve 10 to slide up when subjected to the force of sucking. Valve housing 19 and valve seal o-ring 14 block passage of liquids when valve 10 is in a closed position. Seal o-ring 14 is positioned an a depression along the base of valve 10 to block passage of liquid in a closed valve position. Seal o-ring 15 is placed on outside of housing 19 and blocks passage of liquid from in between housing 19 and spout 6. FIG. 20 illustrates a relatively sophisticated valve design. More cheaper and simpler valves can also be used. For example, a miniature umbrella valve can be used.

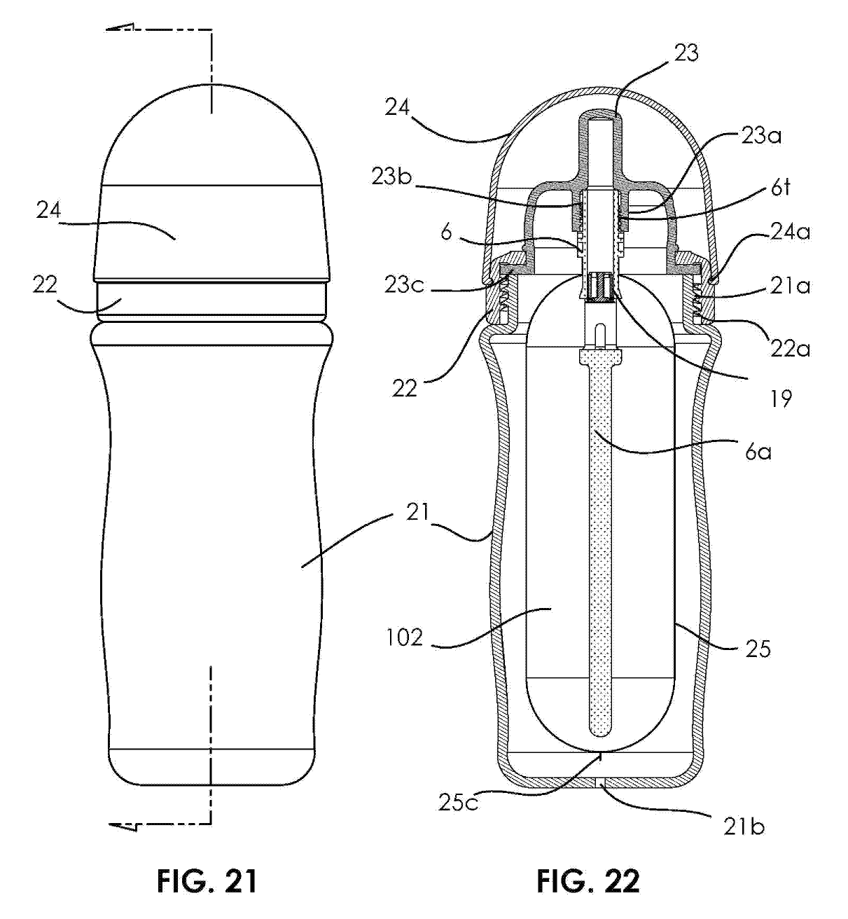

FIG. 21 illustrates front view of baby bottle assembly from the outside with cap 24 in place. Illustrated in this view is baby bottle with baby bottle housing 21, nipple housing closure 22, and nipple protective cap 24.

FIG. 22 illustrates cross-section side view of baby bottle assembly of FIG. 21, Illustrated in this view are liquid container spout 6, flexible container film separator 6a, spout mounting thread 6t, valve housing 19, baby bottle housing 21, baby bottle housing closure mounting thread 21a, baby bottle housing air exchange hole 21b, nipple bottle housing closure 22, nipple bottle housing closure thread 22a, nipple 23, nipple liquid container spout threaded receptacle 23a, nipple spout receptacle thread 23b, nipple mounting flange 23c, nipple protective cap 24, nipple protective cap snap ring 24a, flexible liquid container 25, flexible liquid container 25c, air-less liquid 102. The construction of bottle in FIG. 22 is similar to that in FIG. 15 except for the addition of a rigid baby bottle housing 21. The use of an airless container minimizes suction of air by a baby, and may reduce the need for burping a baby.

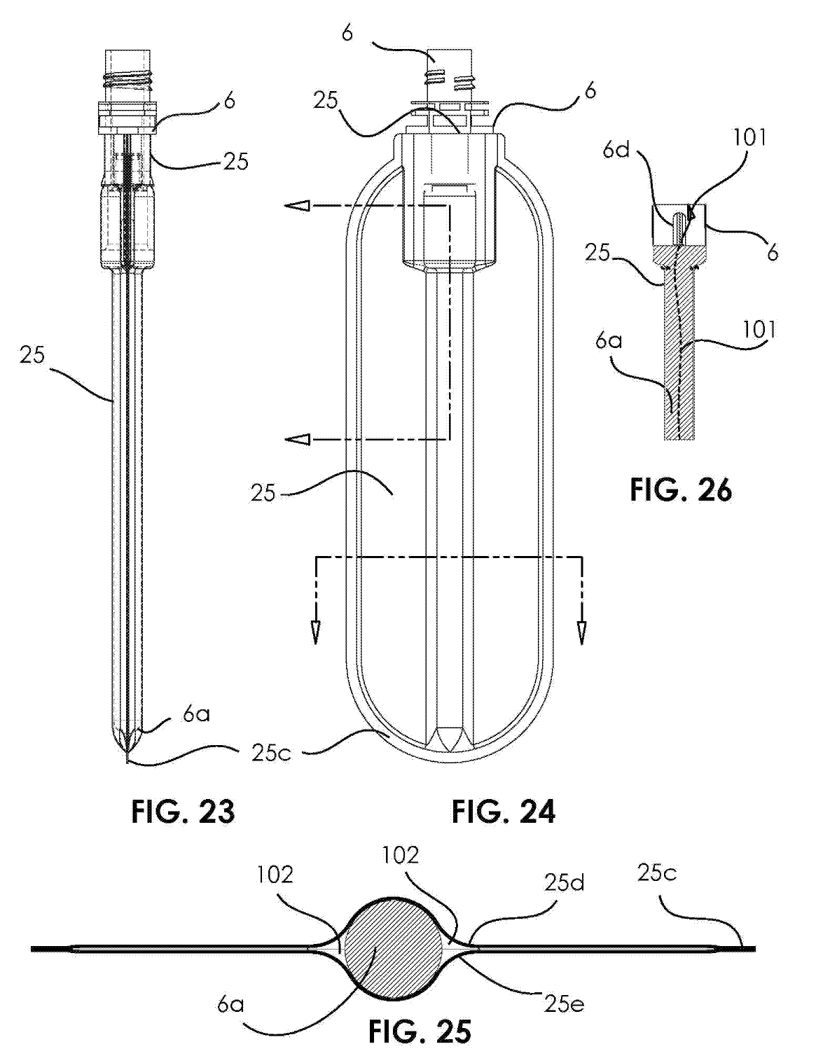

FIG. 23 illustrates front view of baby bottle air-less liquid container at collapsed minimum volume liquid container spout 6, flexible container film separator 6a, flexible liquid container 25, flexible container welded scam 25c.

FIG. 24 illustrates side view of baby bottle liquid container. In this figure, all the liquid has been consumed. Illustrated is a collapsed minimum volume liquid container spout 6 having no liquid, flexible container film separator 6a, flexible liquid container 25, and flexible container welded seam 25c.

FIG. 25 horizontal cross-section of front view showing liquid flow spaces 102 created by spacer 6a along both sides, liquid container spout 6, flexible container film separator 6a, flexible liquid container 25, flexible container welded seam 25c, front flexible container film 25d, rear flexible container film 25e, and air-less liquid 102. This view illustrates that when the liquid is consumed, the container film 25d. When front/back slots 6W are covered, side slots 6d are still open and can allow for movement of liquid.

FIG. 26 illustrates a partial vertical cross-section of front view showing liquid flow thru spout side slot near and far sides (far side shown). Illustrated in this figure are liquid container spout 6, flexible container film separator 6a, spout liquid flow side access slot 6d, flexible liquid container 25, and flexible container welded seam 25c. When front/back slots 6W are covered, side slots 6d are still open and can allow for movement of liquid.

FIG. 27 illustrates a female mannequin head with a cavity inside for placing a bottle. The bottle can be placed from back of the head inside of the cavity. The nipple of the bottle can be exposed and accessible through an opening in the mouth of the mannequin. A person would put its lips against the lips of the mannequin and then suck fluid from nipple.

FIG. 28 illustrates a female mannequin torso with a cavity inside for placing a bottle. The bottle can be placed from behind the torso inside of the cavity. The nipple of the bottle can be exposed and accessible through an opening in the vagina of the mannequin. A person would put its lips against the vagina of the mannequin and then suck fluid from the nipple of the bottle.

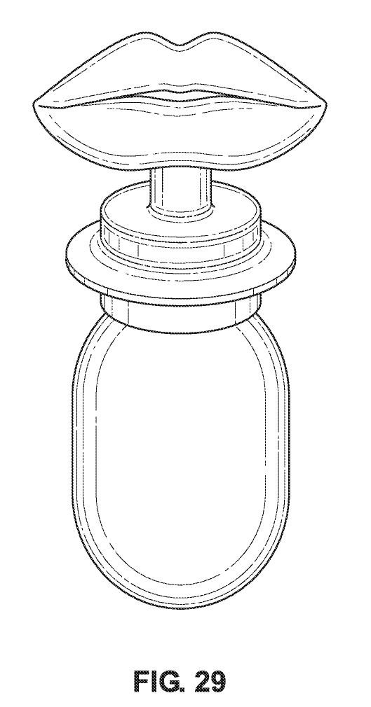

FIG. 29 illustrates a bottle having lips instead of a nipple for sucking. The bottle can be placed in a mannequin and form the lips or another part (vagina) of the mannequin. The person can place his or her lips against the lips of the mannequin to drink.

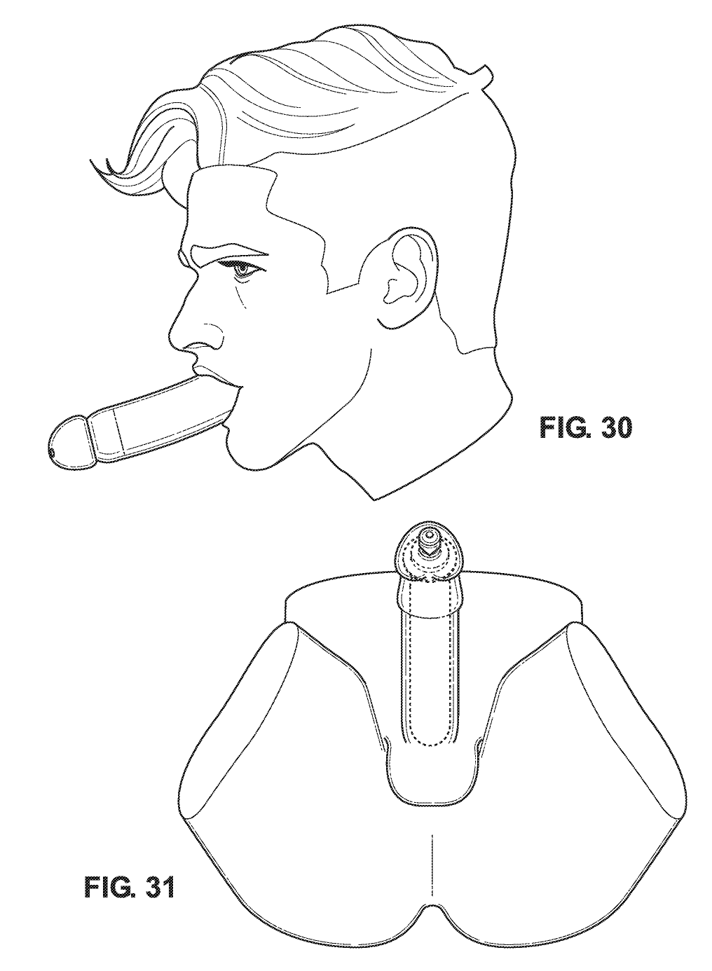

FIG. 30 illustrates a male mannequin head with a cavity inside for placing a bottle. The bottle can be placed from back of the head inside of the cavity. The bottle, in this case phallus shaped, comes out at least by one inch from an opening in the mouth of the mannequin. A person would put its lips against the bottle and then suck fluid from bottle.

FIG. 31 illustrates a male mannequin torso with a cavity inside for placing a bottle. The bottle, in this case phallus shaped, comes out at least by one inch from an opening in the area of the genitals of the mannequin. A person would put its lips against the bottle and then suck fluid from bottle.

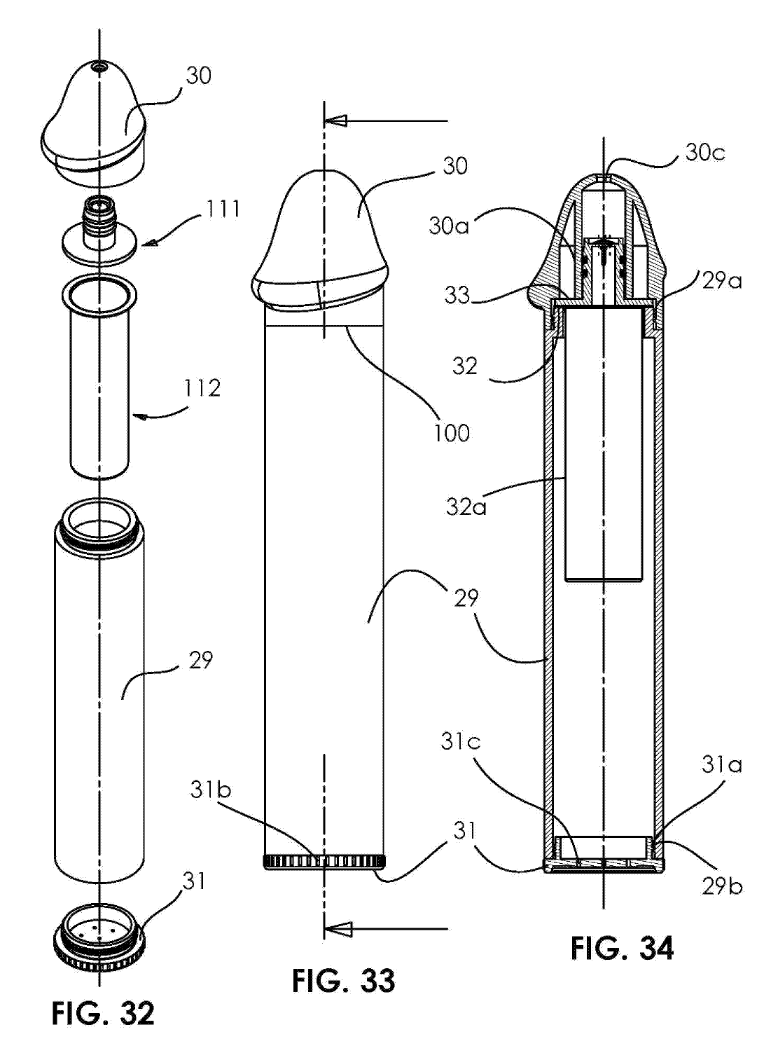

FIG. 32 is an isometric exploded view of adult toy with shaft 29, bottom cap 31, one-way valve assembly 111, liner cup 112, and cap (glans) 30. Shaft 29 and bottom cap 31 can be made of polypropylene (pp). A user would put a desired liquid in cup 112 and drink the liquid from the opening in cap 30. Liner cup 112 has a flange portion that rests on shaft 29, and the one-way valve assembly 111 sits on the flange of liner cup 112. The user fills cup 112 with a liquid, puts valve assembly 111 on top of it and then screws the threaded cap 30. The user can also use this embodiment without any valve 111 where liquid from cup 112 directly flows to cap 30 and to the outside without going through valve 111.

FIG. 33 illustrates front side view of the novelty in FIG. 32 with all the components in place. In this view, illustrated are shaft 29, cap (glans) 30, bottom cap 31, bottom cap knurl 31b, and cap body split line 100.

FIG. 34 illustrates cross-section of the novelty in FIG. 33. Illustrates in this figure are shaft 29, shaft cap thread 29a, shaft bottom cap thread 29b, cap valve assembly receptacle 30a, cap liquid outlet 30c, bottom cap 31, bottom cap shaft thread 31a, bottom cap air vent 31c, and valve chassis 33. Cup 112 (label) has a flange portion that sits on the threaded portion of shaft 29. The liquid inside of cup 112 is in fluid communication with valve 111.

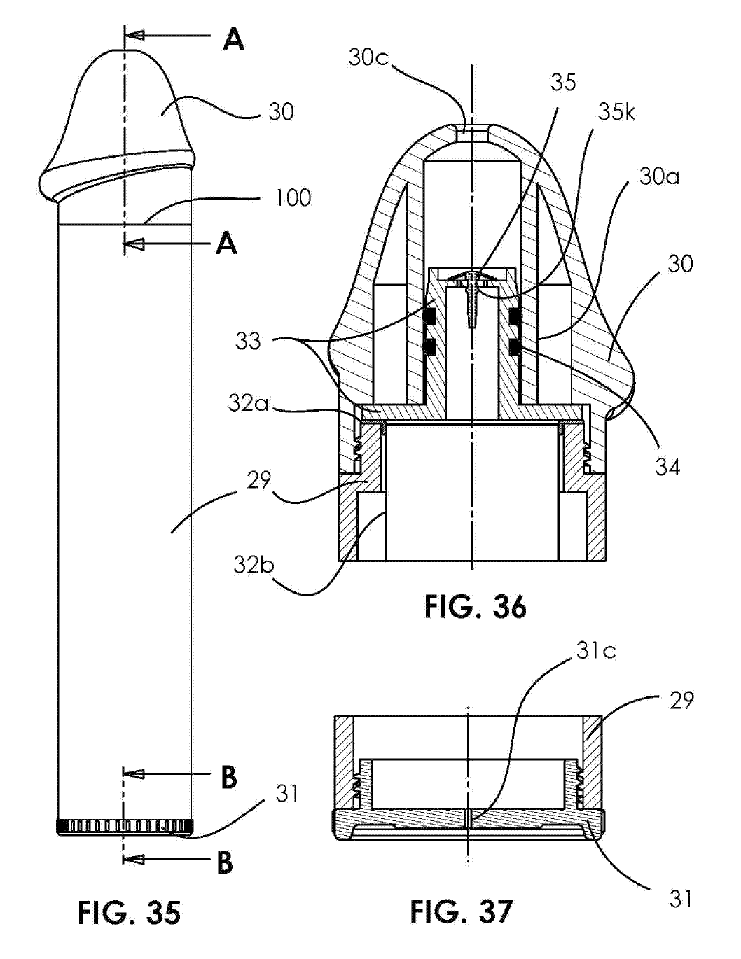

FIG. 35 illustrates another side view of the novelty with shaft 29, cap (glans) 30. bottom cap 31, and cap body split line 100.

FIG. 36 illustrates section A-A of FIG. 35 side view. Illustrated in this figure are shaft 29, material cap (glans) 30, cap valve assembly receptacle 30a, cap liquid outlet liner flange (as a sealant, compressed between, item 33 and item 29 via item 30 cap closure) 32a, thin flexible liner membrane (non-stretchable for example 0.08 mm thin film) 32b, valve assembly chassis 33, o-ring sealer (compressed between item 30a and 33 as a sealant) 34, umbrella valve (elastic) 35, umbrella mounting keeper (elastic) 35k.

FIG. 37 illustrates section B-B of FIG. 35 with side view of shaft 29, bottom cap 31, and bottom cap air vent 31c. Cap 31 is threadably attached to shaft 29, and can be removed when needed to access the inside of shaft or for washing the novelty. Vents 31c allow for movement of air to inside of shaft as liquid leaves the shaft.

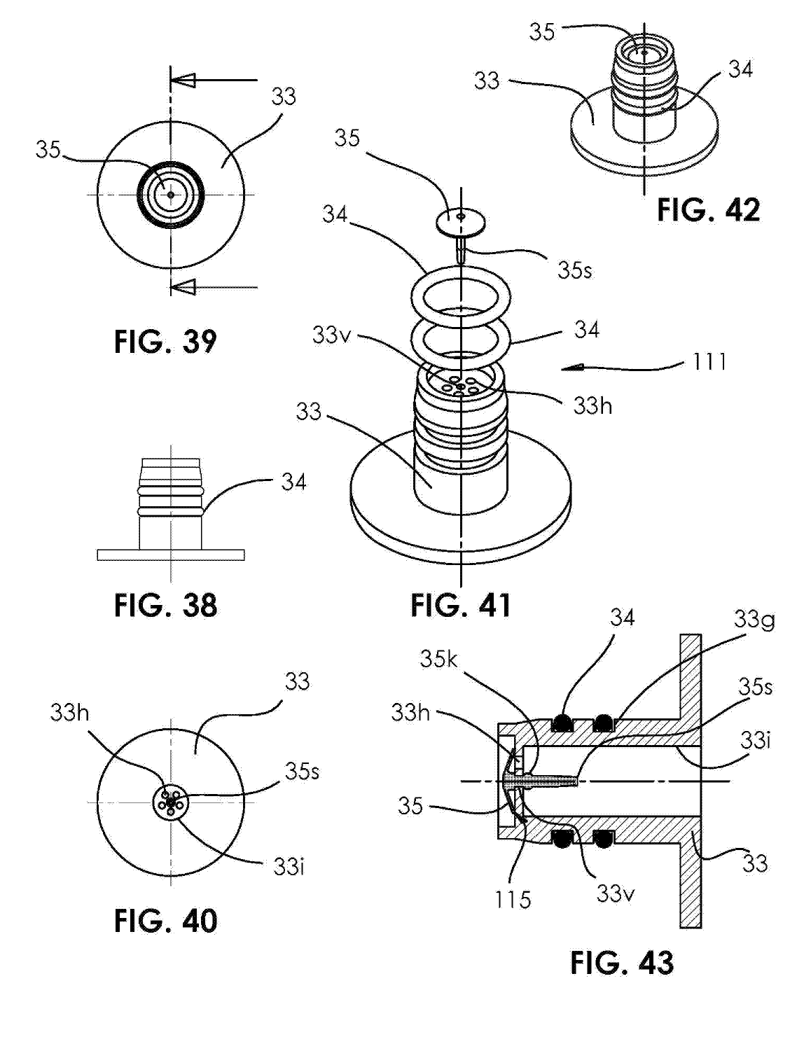

FIG. 38 illustrates a side view of valve assembly o-ring sealer 34 (compressed between item 30a and 33 as a sealant).

FIG. 39 illustrates atop view of valve assembly with valve assembly chassis 33 and umbrella valve (elastic) 35.

FIG. 40 illustrates bottom view of valve assembly with valve assembly chassis 33, valve assembly chassis liquid flow hole 33h, valve assembly liquid inlet 331, and valve stem (elastic) 35s.

FIG. 41 illustrates an exploded isometric view of one way valvee assembly 111 with valve assembly chassis 33, valve assembly chassis liquid flow hole 33h, umbrella valve mounting hole 33v, o-ring sealer (compressed between item 30a and 33 as a sealant) 34, umbrella valve (elastic) 35, and valve stem (elastic) 35s.

FIG. 42 illustrates isometric view of valve assembly with valve assembly chassis 33.

o-ring sealer (compressed between item 30a and 33 as a sealant) 34, and umbrella valve (elastic) 35.

FIG. 43 illustrates cross section of top view of FIG. 39 valve assembly with valve assembly chassis 33, chassis o-ring groove 33g, valve assembly chassis liquid flow hole 33h, valve assembly liquid inlet 33i, umbrella valve mounting hole 33v, o-ring sealer (compressed between item 30a and 33 as a sealant) 34, umbrella valve (elastic) 35, umbrella valve mounting keeper (elastic) 35k, valve stem (elastic) 35s, and umbrella valve seat normally closed 115.

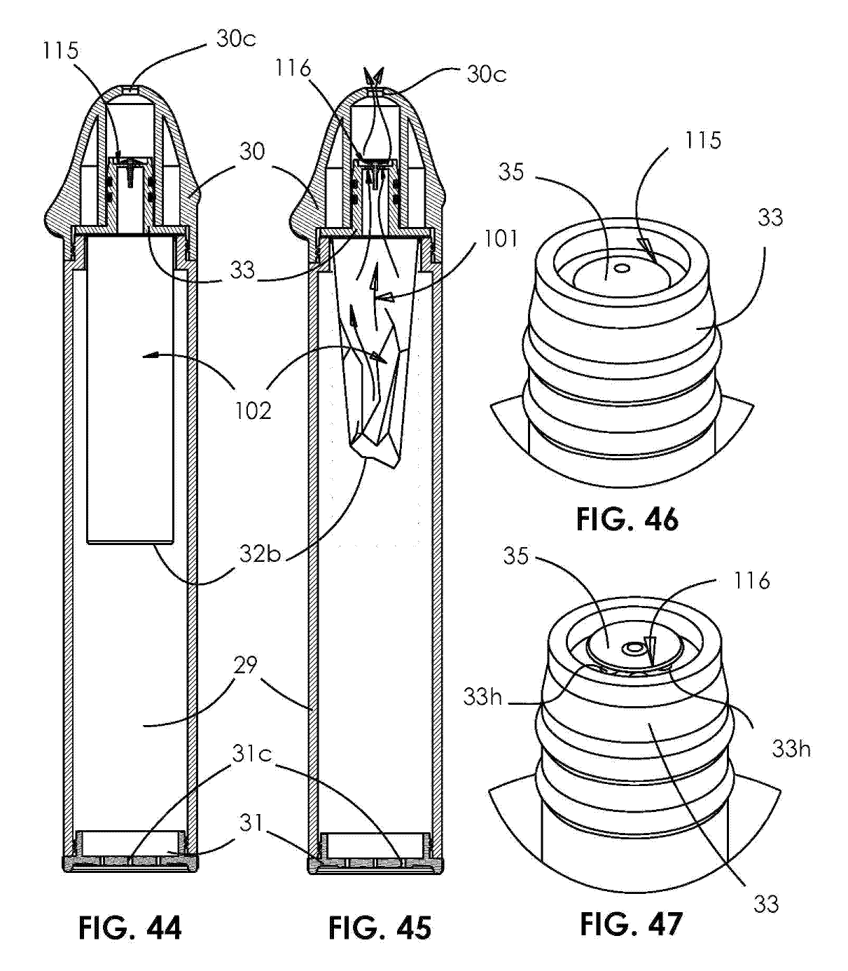

FIG. 44 cross section of toy with valve in normally closed position. This figure illustrates shaft 29, material cap (glans) 30, cap liquid outlet 30c, bottom cap 31, bottom cap air vent 31c, thin flexible liner membrane (full capacity with no suction present) 32b, valve assembly chassis 33, airless liquid 102, and umbrella valve seat 115 (normally in a closed position in the absence of a sucking force).

FIG. 45 illustrates cross section of toy with valve in open position via user mouth suction. Liquid 102 leaves cup 101 as cup 101 collapses to compensate for loss of liquid. Liquid 102 passes through the one way valve in an open position and comes out of the opening on the cap 30c. Illustrates in this view are cap liquid outlet 30c, bottom cap 31, bottom cap air vent 31c, thin flexible liner membrane, collapsed when suction present 32b, valve assembly chassis 33, airless liquid 102, umbrella 116 valve seat, opened via user mouth suction. Cup 101 can be reusable or disposable.

FIG. 46 illustrates isometric view of valve assembly in a closed position. Illustrates in this view are valve assembly chassis 33, valve assembly chassis liquid flow hole 33h, umbrella valve (elastic) 35, and umbrella valve seat normally closed 115.

FIG. 47 illustrates isometric view of valve assembly in an open position. Illustrates in this view are valve assembly chassis 33, valve assembly chassis liquid flow hole 33h, umbrella valve (elastic) 35, and umbrella valve seat opened via user mouth suction 116.

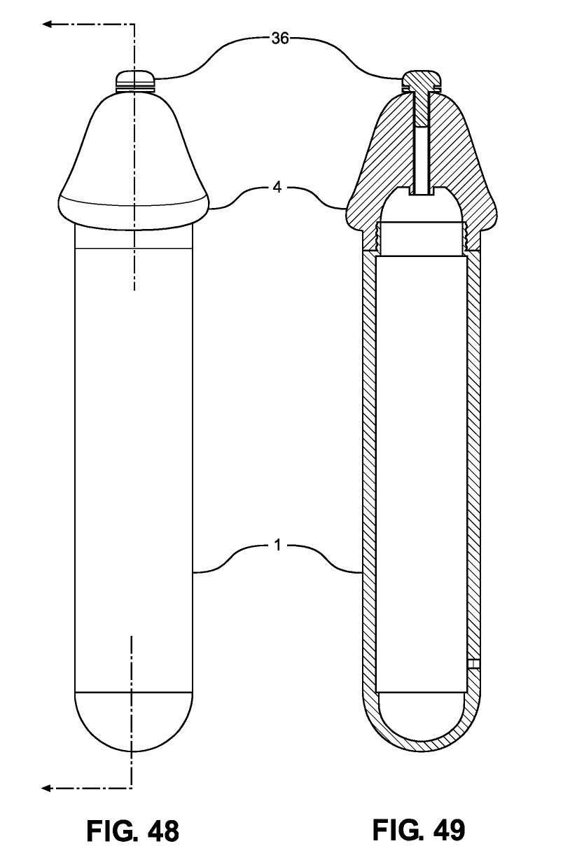

FIGS. 48 and 49 illustrate a phallus shaped cup where a user fills in the liquid as desired. FIGS. 48 and 49 illustrate a straight container with a cap in shape of glans. The cap can be screwed on and off to fill in the container. A person would then put the cap, in shape of glans, in a mouth and suck liquid through a channel inside of the cap. The channel can be placed entirely inside of the glans, with only an opening of the channel exposed from the outside. The channel can further have a plug 36 that blocks flow of liquid. The step of the plug 36 can rest in the channel inside of the channel, and a handle portion on the outside for removal. The entire glans can form the cap, with the container below being a substantially straight cylinder. The glans portion can be filled, and the channel present as a cutaway tubular channel that is straight and has a diameter of less than 1 cm. The toy is configured so that the cap shaped like a glans is placed in the mouth or at least makes contact with the mouth. The one layer housing shown in this embodiment can be used with any embodiment described above.

### REFERENCES

1. body soft cover (over mold)
1a. mounting suction cup
1b. body housing soft shell air exchange hole
2. body housing hard shell (over mold)
2a. body housing hard shell air exchange hole
2b. cap body split line
3. body housing cap hard shell (over mold)
3a. body housing cap snap ring
3b. body housing cap snap deflection slot
4. cap (glans) soft cover (over mold)
4a. cap (glans) soft cover liquid access hole
5. cap hard shell (over mold)
5b. Cap threaded receptacle, reusable base
5c. Cap threaded receptacle, disposable liquid container
6. liquid container spout
6a. flexible container film separator
6d. spout liquid flow side access slot
6s. separator puncture-proof spherical tip
6t. threading
6w. spout liquid flow front/back access slot
7. flexible liquid container
7a. flexible container welded seam
8. short flexible liquid container
8a. flexible container welded seam
9. liquid container spout
9a. flexible container film separator
10. valve
12. cap (nipple) soft cover (over mold)
12a. cap (nipple) soft cover liquid access hole
14. valve seal o-ring (inside of housing)
15. valve housing seal o-ring (outside of housing)
17. valve spring
18. valve spring retainer cap
19. valve housing
20. valve retainer ring
21. liquid container shipping cap (throw away)
26. bottom container
27. threaded closure
28. threaded closure plug
30a. cap Valve assembly receptacle
30c. cap liquid outlet 31. bottom cap, material example: polypropylene (pp)
31a. bottom cap shaft thread
31b. bottom cap knurl
31c. bottom cap air vent
32a. liner flange (as a sealant, compressed between item 33 and item 29 via item 30 cap closure)
32b. thin flexible liner membrane (non-stretchable for example 0.08 m in thin film)
33. valve assembly chassis
33h. valve assembly chassis liquid flow hole
33i. valve assembly liquid inlet
33g. chassis o-ring groove
33v. umbrella valve mounting hole
34. o-ring sealer (compressed between item 30a and 33 as a sealant)
35. umbrella valve (elastic)
35k. umbrella mounting keeper (elastic)
35s. valve stem (elastic)
36. Plug
100. cap body split line
101. liquid flow direction
102. air-less liquid
103. cap liquid container engagement threads
104. cap/body over molds engagement threads
110. mannequin
110a. mannequin breast
110b. mannequin breast threaded insert receptacle (mounting tbd)
111. one-way valve assembly
112. liner cup
115. umbrella valve seat normally closed
116. umbrella valve seat opened via user mouth suction

What is claimed is:

1. A container for drinking liquid comprising:
a) a reservoir for holding liquid, the reservoir made from a material that shrinks as liquid leaves the reservoir,
b) an opening for the liquid to leave the reservoir and exit the container; and
c) a one way valve configured to be actuated by a person sucking the opening;
wherein when the person sucks, the one way valve opens and the liquid leaves the container while the reservoir shrinks to compensate for volume of the liquid that left the container.

2. The container of claim 1, further comprising a housing in which the container is placed.

3. The container of claim 2, wherein the housing is phallus shaped.

4. The container of claim 2, wherein the housing is shaped as a cylinder.

5. The container of claim 2, wherein the housing is shaped as a baby milk bottle.

6. The container of claim 2, wherein the housing is shaped as an adult toy.

7. The container of claim 2, wherein the housing is made from a rigid material that does not shrink due to shrinkage of the container.

8. The container of claim 2, further comprising a separator inside of the reservoir to maintain stability of the reservoir when liquid leaves the container

9. The container of claim 1, further comprising a slot before the one way valve for liquid to leave the reservoir.

10. The container of claim 2, wherein the housing is made from at least two layers, with an outside layer that is made from a material that is compressible and an inner layer made from a material, that is not compressible.

11. The container of claim 2, wherein the housing is made from two parts, a body and a cap. the body and the cap configured to threadably be attached to each other.

12. The container of claim 11, wherein the cap has a channel for liquid to move outside of the housing.

13. The container of claim 11, wherein the cap in a shape of a nipple to simulate breast of a woman.

14. The container of claim 1, further comprising a member fabricated from one piece, the member having a spout on top, a slot in liquid communication with the spout, and a separator positioned below the slot, wherein liquid leaves through the slot and moves through the spout to outside of the container.

15. The container of claim 14, wherein the member is attached to an extension coming downward from the cap, resulting in the member to be in fluid communication with outside of the housing.

16. The container of claim 14, wherein the valve is placed above the spout.

17. The container of claim 14, wherein the member is sealed to the material that shrinks.

18. The container of claim 11, wherein the reservoir is a cup with a flange, the flange portion resting on the body portion of the housing.

19. The container of claim 18, wherein the one way valve is part of an assembly that rests on the flange portion of the cup.

20. A container for drinking liquid comprising:
a) a housing in a shape of a phallus, the housing having a body and a cap, inside of the body of the housing having a reservoir for a liquid, the cap configured to be removably attached to the housing; and
b) a channel present as a void in the cap configured to carry liquid from inside of the housing;to outside of the container; and
c) a removable plug for closing the channel from outside of the housing;
wherein the reservoir is filled by removing the cap and pouring the liquid into the reservoir, >and the liquid is consumed through the channel.
